(19) United States
(12) Patent Application Publication
(10) Pub. No.: US 2016/0095768 A1
(43) Pub. Date: Apr. 7, 2016

(54) Post-Operative Assistive Device

(71) Applicants: Keith Gordon, SR., Sugar Land, TX (US); Hana Salem, Sugar Land, TX (US)

(72) Inventors: Keith Gordon, SR., Sugar Land, TX (US); Hana Salem, Sugar Land, TX (US)

(21) Appl. No.: 14/877,339

(22) Filed: Oct. 7, 2015

Related U.S. Application Data
(60) Provisional application No. 62/060,943, filed on Oct. 7, 2014.

(51) Int. Cl. A61G 5/12; A47C 7/02; A47C 7/46

(52) U.S. Cl. CPC A61G 5/12; A47C 7/46; A47C 7/021; A47C 7/022; A61G 2005/1091

(57) ABSTRACT

A post-operative assistive sitting device configured to prevent pressure being applied to a post-operative patient's recovery area thereby allowing a patient to sit and conduct normal daily activities after a medical procedure. The post-operative assistive sitting device includes a chair that defines an opening and a series of cushions and paddings surrounding the opening to alleviate the pressure and discomfort from the recovery area without disturbing the buttocks as the patient sits or lies in a natural position.

### CROSS-REFERENCE TO RELATED APPLICATIONS

This application claims the benefit of U.S. Provisional Patent Application Number 62/060,943, filed on Oct. 7, 2014, which is incorporated herein in its entirety by reference.

### STATEMENT REGARDING FEDERALLY SPONSORED RESEARCH OR DEVELOPMENT

Not Applicable

### BACKGROUND OF THE INVENTION

1. Field of Invention

This invention pertains to post-surgical recovery assistive device, and more particularly, to a sitting device for supporting the posterior of a patient's body such as the patient's buttocks, lower back and thigh regions during recovery from a medical procedure.

2. Description of the Related Art

Today, many Americans are undergoing cosmetic or plastic surgical procedures to enhance their physical appearance. Among the many procedures available, buttock augmentation or implants has become one of the most popular among those who wish to achieve a more desirable and proportional figure. Buttock augmentation is a procedure that reshapes and enhances the gluteal area, providing the patients with an uplifted and shapelier buttock profile. The most frequent methods for enlarging and reshaping buttocks are autologous fat transfer, which is a grafting procedure utilizing the patient's own natural fatty tissue, and buttock implants. These procedures can cause tremendous discomfort for the patients as is the case with virtually any surgical procedure. However, the recovery period may be slightly longer and more painful in the buttock areas, because this body region is used for physical activities such as walking, running, and even standing.

Pain, soreness, numbness, swelling, and bruising can occur during the recovery; and full recovery may take several months. Specifically with butt implants, the implants could also shift and cause the buttocks to be asymmetrical if the patient does not exercise care, especially with sitting, during recovery. More serious issues such as infection, especially when implants are placed through a buttock crease incision, is a risk that must be closely monitored. It is important for patients to keep the incision site clean and avoid to unnecessary contact and pressure on the gluteal area.

Generally, the patient is not permitted to sit, for several days after the surgery. After this time, a patient is advised to sit with a soft pillow placed beneath the patient's hamstrung muscles but not touching the buttock region, so that the patient's buttocks are suspended above the seating surface and there is no pressure on the newly augmented buttock. Direct pressure must be kept off the buttocks for at least eight weeks, so sitting without a pillow is not allowed for that period of time. And, frequently, the patient is required to wear special tight compression garments to keep the buttock area compressed. Patients are also instructed to lie on their stomach while doing many daily activities such as sleeping and while watching TV to avoid placing pressure on the patient's buttocks. After implant surgery, a patient often can return to work in two to three weeks, but the patient must use a pillow when sitting so that there is no pressure on the buttocks. The restriction of direct contact to the buttock region can cause tremendous inconvenience and trouble for the patient during the recovery.

Currently there are no known products that provide comfort or postural relief for patients who have received medical procedures/injuries to the buttocks region. In light of the above, there is a need for a product that provides comfortable relief for the patient and allows the patient to sit without applying pressure to the patient's buttocks area.

### BRIEF SUMMARY OF THE INVENTION

Described herein is a post-operative assistive sitting device configured to prevent pressure being applied to a post-operative patient's buttocks, referred to herein as “the recovery area,” thereby allowing a patient to sit and conduct normal daily activities after a medical procedure. In some embodiments, the post-operative assistive device includes a chair that defines an opening in the seat of the chair and a series of cushions and paddings surrounding the opening to alleviate the pressure and discomfort from the problematic areas without disturbing the buttocks as the patient sits or lies in a natural position. In other embodiments, the post-operative assistive sitting device provides a separable and portable booster seat configured to be used in conjunction with an office chair or the like. The interior seat area of the booster seat also defines an opening and padding surrounding the edges of the opening to absorb the diverted weight as the patient sits in a natural position.

### BRIEF DESCRIPTION OF THE DRAWINGS

The above-mentioned and additional features of the invention will become more clearly understood from the following detailed description of the invention read together with the drawings in which:

FIG. 1A is a perspective view of an exemplary embodiment of the assistive sitting device constructed in accordance with several features of the present general inventive concept;

FIG. 1B is a perspective view of another exemplary embodiment of the assistive sitting device constructed in accordance with several features of the present general inventive concept;

FIG. 2 is an exploded view of another embodiment of the assistive sitting device constructed in accordance with several features of the present general inventive concept;

FIG. 3 is a perspective view of the assistive sitting device of FIG. 2, showing the booster seat inserted into the chair.

FIG. 4 is an exploded view of the assistive device of FIG. 2, showing the an additional cover member of assistive device which is adapted for returning the chair member to its conventional configuration.

### DETAILED DESCRIPTION OF THE INVENTION

In accordance with several features of the present general inventive concept, various exemplary embodiments of a post-operative assistive sitting device are disclosed herein and in the accompanying figures. In several embodiments, the assistive sitting device provides a recovery chair that is configured to prevent pressure from being applied to the recovery area, thereby allowing a patient to sit and conduct normal daily activities. The chair defines an opening to allow a patent's recovery area to fit through. Cushions and padding are provided to the area surrounding the opening and the lower back region of the chair to alleviate the pressure and discomfort from the recovery area without disturbing the buttocks. Thus, when the patient sits down, the extra padding or cushion of the device provides extra support without applying pressure to the patient's recovery area. The chair maintains substantially equal pressure distribution throughout the surface area of the body that is in contact with the chair while preventing direct contact of the buttock region to the chair. Furthermore, the opening and the padding configuration may be integrated into the recovery chair itself or may be detachable from the chair, thereby allowing the post-operative assistive sitting device to be portable and adaptable to various sitting positions and chairs.

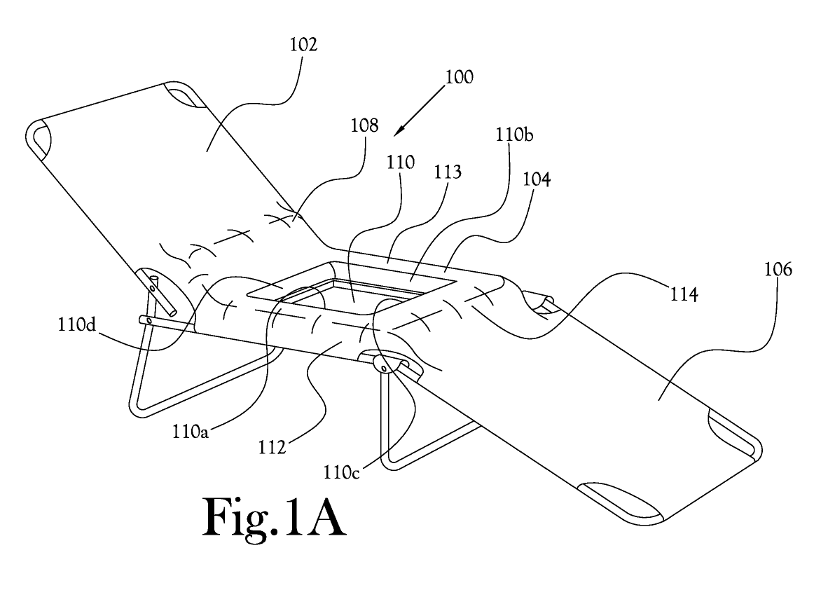

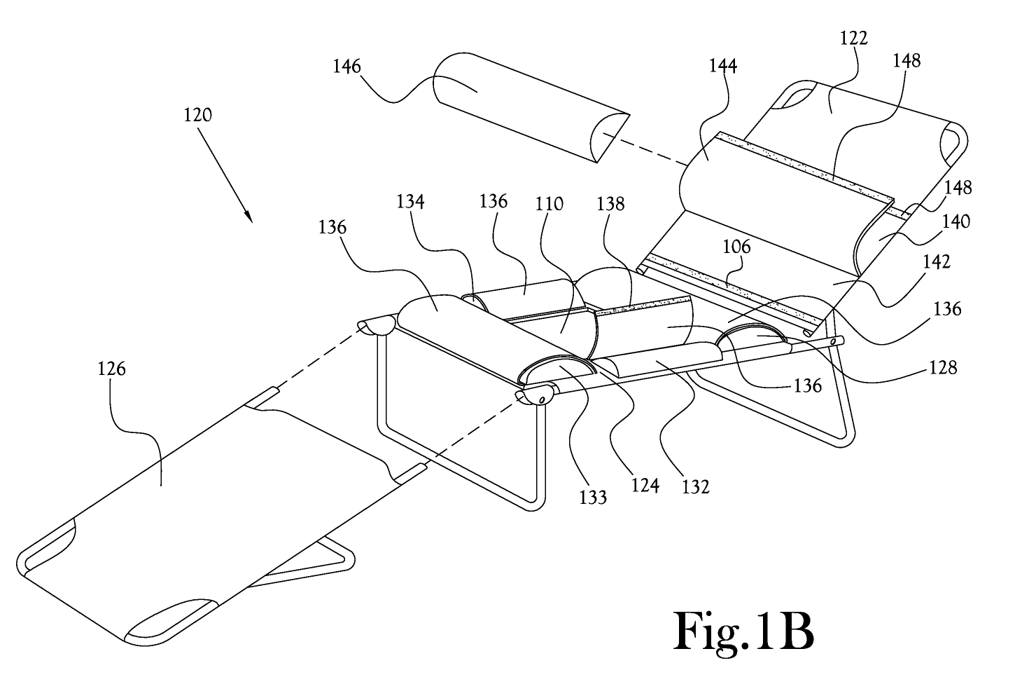

One embodiment of the assistive sitting device constructed in accordance with several features of the present general inventive concept is illustrated in FIG. 1. With initial reference to FIG. 1A, the post-operative assistive sitting device is constructed in a one-piece chair apparatus 100 having an opening 110 and paddings 108, 112, 113, and 114 integrated into the chair 100. The chair 100 includes a back panel 102, a sitting panel 104 and a lower panel 106. Each of the panels may be fabricated from a generally rigid or semi-rigid material of the type commonly used in the manufacture of chairs, for example plastic, cloth, leather, or the like, such that the panels of the post-operative sitting device provide sufficient support for a human body. In several embodiments, the three panels 102, 104, and 106 of the chair 100 may include multiple layers of material. In the embodiment of FIG. 1A, each panel defines a rectangular shape. However, it will be recognized that other suitable shapes, such as for ovular, triangular, and the like, may be used without departing from the spirit and scope of the present general inventive concept. The panels 102, 104, and 106 may be connected in a continuous one piece construction or may be individually defined.

The middle sitting panel 104 includes a centrally disposed opening 110 for allowing a patient's buttock region to fit through. For example, in the illustrated embodiment, the four edges 110a, 110b, 110c, and 110d defines the opening 110, which is of the approximate size as a patient's buttock region. The opening 110 is adapted to receive a patient's recovery area when the patient sits in the chair 100, thereby allowing the patient to sit down without the recovery area touching the surface of the chair 100. In the embodiment of FIG. 1A, the opening 110 defines a rectangular shape. However, it will be recognized that other shapes or sizes, such as for example ovular, circular, triangular, and the like, may be used without departing from the spirit and scope of the present general inventive concept.

The middle sitting panel 104 also provides support paddings that protrude from the area surrounding the edges 110a, 110b, and 110c of the opening 110. The support paddings may be formed generally by a cushioned material or from a combination of, for example, gel, foam, cotton, or the like, such that the padding may alleviate the pressure and discomfort from the problematic areas without disturbing the buttocks. For example, as illustrated in FIG. 1, the lower edge padding 114 is configured to support the thigh region of the patient. The two buttocks side paddings 112 and 113 projecting along the two side edges 110a and 110b of opening 110 are configured to support the lateral region of the patient's buttocks. In some embodiments, the lateral buttock support paddings 112 and 113 and the thigh support padding are integrally connected. The paddings surrounding the two side edges 110a and 110b and the lower edge 110d of the opening 110 are provided to enhance the positioning effect of the buttocks accepted by the opening, which may prevent the buttocks from shifting.

The back panel 102 is configured to support the back, neck, and head of the patient. The back panel 102 provides a back support padding 108 projecting along a lower edge of the back panel 102. According to one embodiment of the present invention, the back padding 108 may be curved or adapted to provide lumber support in the back panel 102. In some embodiments, the back padding 108 is woven into the back panel 102.

According to one embodiment of the present invention, the paddings provided by the middle sitting panel 104 may be configured such that the opening 110 becomes adjustable in position from front to back with respect to the middle sitting panel 104. In these embodiments, the recovery area can be supported at the optimum position by changing the position of padding in the middle panel according to the position and size of the patient's buttock region.

A further exemplary embodiment of the assistive sitting device constructed in accordance with several features of the present general inventive concept is illustrated in FIG. 1B. The post-operative assistive sitting device is defined by a two-piece chair apparatus 120 having an opening 110 and paddings 128, 132, 133, and 134 which are secured to the chair 120 by means of fabric flaps 136. Flaps 136 are secured to the body of the chair 120 by releasable means such as cooperating hook and loop fasteners 138. It will be appreciated by those skilled in the art that there are other means of releasably securing flaps 136 to the chair 120. The chair 120 includes a back panel 122, a sitting panel 124 and a lower panel 126. Which, as discussed above in conjunction with chair 100 illustrated in FIG. 1A, may be fabricated from a generally rigid or semi-rigid material of the type commonly used in the manufacture of chairs, for example plastic, cloth, leather, or the like, such that the panels of the post-operative sitting device provide sufficient support for a human body.

The back panel 122 is configured to support the back, neck, and head of the patient. The back panel 122 provides a pair of spaces 140 and 142 for receiving a back support pad 146 which is adapted to provide lumbar support to the user of chair 120. Spaces 140 and 142 provide for selection of high lumbar support or lower lumbar support, respectively. A flap 144 is secured to the back panel 122 and secures back support pad 146 to the lower back panel by means of hook and loop fastener 148, or other similar means as discussed above. Whereas in FIG. 1A, lower panel 106 is shown as being contiguous with panels 102 and 104, in the embodiment illustrated in FIG. 1B, lower panel 126 is selectively removable from chair 120. This allows chair 120 to function as a standalone chair when lower panel 126 is removed, or to function as a chaise lounge when lower panel 126 is connected to the remainder of chair 120.

As mentioned above, the opening and the padding configuration may be detachable from the chair, thereby allowing the post-operative assistive sitting device to be portable and adaptable to various sitting positions and chairs. In some embodiments, the present invention provides a booster seat that incorporates the opening and the padding configuration and is adapted to be used in conjunction with travel or car seat chairs as well as an office chair that can provide the same relief to patient's recovery area.

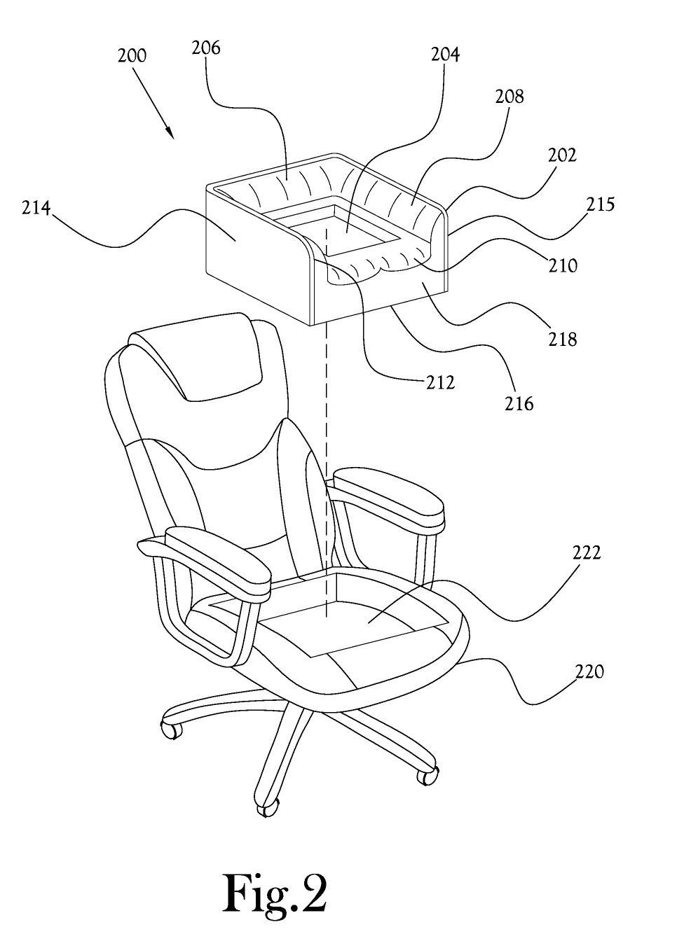

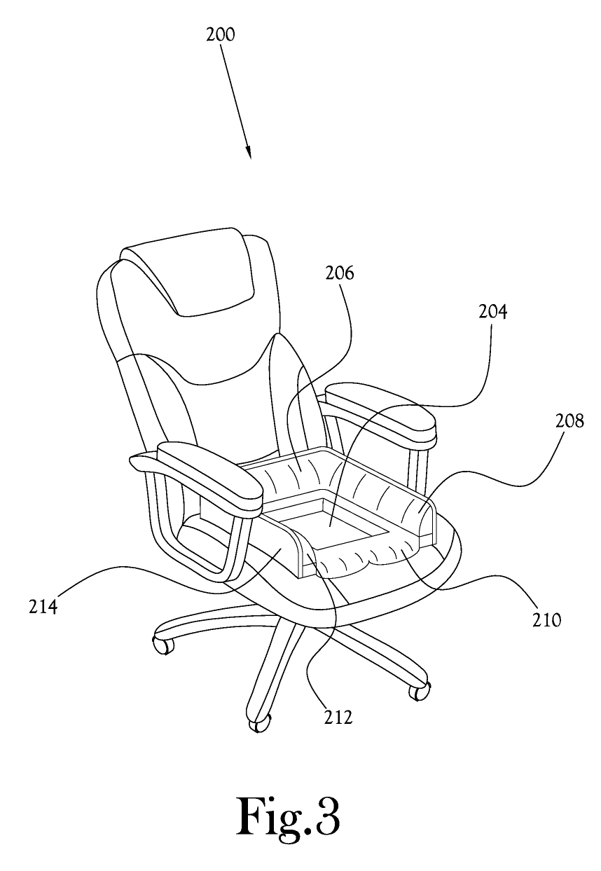

Another embodiment of post-operative assistive sitting device constructed in accordance with several features of the present inventive concept is illustrated in FIGS. 2-4. A booster seat and the buttock support padding is adapted to be selectively coupled with and separable from a chair. For example, as shown in FIG. 2, the post-operative assistive sitting device 200 may include a chair 220 and a portable booster seat apparatus 202 that is separable from the chair 220. The booster 202 is defined by an outer shell, which includes two sidewalls 214, 215, a back wall (not shown) and a front wall 218 forming a box-like structure. The booster 202 provides padding that fit snugly within the box-like shell. The padding provides a more comfortable support for the area surrounding the patient's recovery area.

The interior of the booster seat apparatus 202 also defines an opening 204. A series of padding or cushions are arranged around opening 204 in order to support the back and the buttocks of a patient. In particular, the opening 204 is adapted to enclose a patient's buttocks region and thereby prevent the recovery area from contacting the surface. As shown in FIG. 2, the thigh support padding 210 of the booster 202 is configured to support the thigh region of the patient. The lateral buttocks side padding 212 and 208 projecting along the two side edges of opening are configured to support the buttocks of the patient. In some embodiments, the lateral buttocks side support padding 212 and 208 and the thigh support padding 210 are integrally connected. The back padding 206 is configured to support the back. Further, the back and side padding can be adapted to provide lumbar support, as will be understood by those skilled in the art. In comparison to the back support padding and the two buttocks support paddings, the thickness of the thigh support padding 210 is smaller in order to provide sufficient room and comfort for the legs when the patient is in a natural sitting position.

As illustrated in FIG. 2, the chair 220 defines a booster receptor 222, which is of the same, approximate size and shape as the base of the booster. The booster receptor 220 is adapted to receive the booster seat. In use, the booster seat 202 is removably affixed to the chair 220. The patient may insert the booster seat 202 into the booster receptor 222 of the chair 220. The height of the outer shell, which includes two sidewalls 214 and 215, a back wall (not shown) and a front wall 218, may vary so long as it can provide sufficient support for the padding to protrude from the chair 220 when the booster 202 is inserted into the chair 220. It will be appreciated by those skilled in the art that booster 202 may be secured to the chair 220 through various means in order to prevent the booster 202 from falling through the booster receptor 222.

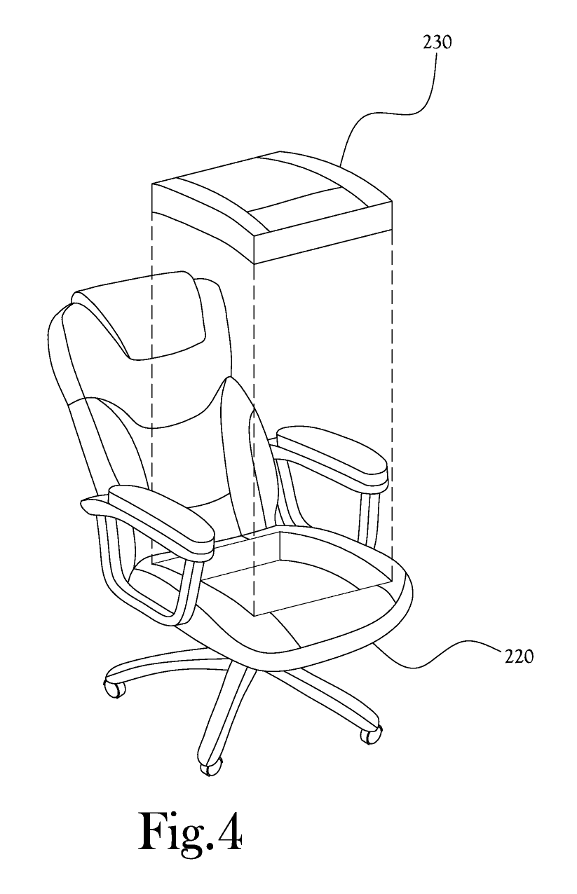

In addition, as illustrated in FIG. 4, the post-operative assistive sitting device 200 may comprise a cover 230 for the chair 200 which is adapted to be received by booster receptor 222 in the middle sitting section 220. When such a cover 230 is provided, the chair 220 may return to its normal usage for when the patient no long needs the additional support in the recovery area.

From the foregoing description, it will be recognized that a post-operative assistive device is provided which prevents extra pressure being applied to the recovery area of a patient after a medical procedure. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A post-operative assistive sitting device for alleviating the pressure and discomfort from a recovery area when a patient is in a resting position, comprising:
a chair having a back panel adapted to engage the patient's back, and a middle panel adapted to support said patient in a sitting position, wherein the middle panel defines a substantially centrally disposed opening having a perimeter; and
a plurality of padding members disposed on said perimeter proximate said centrally disposed opening.

2. The post-operative assistive seating device of claim 1 wherein said padding members are integral with said middle panel.

3. The post-operative assistive seating device of claim 1 wherein said back panel includes a pad member adapted for providing lumbar support.

4. The post-operative assistive seating device of claim 1 wherein said middle panel includes a plurality of flap members for detachably securing said padding members to said middle panel.

5. The post-operative assistive seating device of claim 1 wherein said chair member further includes a lower panel adapted to support the patient's legs, such that said chair member defines a chaise lounge.

6. The post-operative assistive seating device of claim 5 wherein said lower panel is detachably secured to said chair such that said chair is adapted to function as a standalone chair when said lower panel is detached from said chair and to function as a chaise when said lower panel is attached to said chair.

7. The seating device of claim 1 middle panel is defined by a detachable booster seat member further comprising an outer shell defined by a plurality of walls and said chair includes a seating section adapted to receive the detachable booster seat member.

8. The seating device of claim 7 further comprised of a cover to close the opening of the chair.

9. A post-operative assistive sitting device for alleviating the pressure and discomfort from a recovery area when a patient is in a resting position, comprising:
a chair having a back panel adapted to engage the patient's back, wherein said back panel includes a pad member adapted for providing lumbar support, and a middle panel adapted to support said patient in a sitting position, wherein said middle panel defines a substantially centrally disposed opening having a perimeter, and further wherein said middle panel includes a plurality of flap members for detachably securing said padding members to said middle panel; and
a plurality of padding members disposed on said perimeter proximate said centrally disposed opening.

10. The post-operative assistive seating device of claim 9 wherein said padding members are integral with said middle panel.

11. The post-operative assistive seating device of claim 9 wherein said pad member of said back panel is selectively positioned with respect to said back panel.

12. The post-operative assistive seating device of claim 9 wherein said chair member further includes a lower panel adapted to support the patient's legs, such that said chair member defines a chaise lounge.

13. The post-operative assistive seating device of claim 12 wherein said lower panel is detachably secured to said chair such that said chair is adapted to function as a standalone chair when said lower panel is detached from said chair and to function as a chaise when said lower panel is attached to said chair.

14. The seating device of claim 9 middle panel is defined by a detachable booster seat member further comprising an outer shell defined by a plurality of walls and said chair includes a seating section adapted to receive the detachable booster seat member.

15. A post-operative assistive sitting device for alleviating the pressure and discomfort from a recovery area when a patient is in a resting position, comprising:
a booster seat member having a substantially centrally disposed opening for receiving a patient's buttocks and padding defining a perimeter of said centrally disposed opening adapted to support the area proximate the patient's buttocks, wherein said booster seat member is adapted to be detachably supported by a chair member.

16. The post-operative assistive sitting device of claim 15 wherein said booster seat member is defined by an outer shell having at least two sidewalls and a back padding member adapted to support the patient's back.

17. The post-operative assistive sitting device of claim 16 wherein a portion of said perimeter defining padding is defined by side padding and further wherein said back padding and said side padding is adapted to provide lumbar support.
